(19) United States
(12) Patent Application Publication
(10) Pub. No.: US 2021/0289814 A1
(43) Pub. Date: Sep. 23, 2021

(54) A METHOD OF FEEDING MONOGASTRIC ANIMALS IN ORDER TO CONTROL THE PRESENCE OF BACTERIA IN THESE ANIMALS

(71) Applicant: Nutreco Nederland B.V., Boxmeer (NL)

(72) Inventors: Petra Johanna Roubos-van den Hil, Boxmeer (NL); Janneke Allaart, Boxmeer (NL)

(21) Appl. No.: 16/326,430

(22) PCT Filed: Aug. 25, 2017
(86) PCT No.: PCT/NL2017/050558

§ 371 Date: Feb. 19, 2019

(30) Foreign Application Priority Data
Aug. 26, 2016 (NL) 2017374

(51) Int. Cl. A23K 10/18; A23K 10/30; A23K 50/30; A23K 50/60; A23K 50/75

(52) U.S. Cl. CPC A23K 10/18; A23K 10/30; A23K 50/75; A23K 50/60; A23K 50/30

(57) ABSTRACT

A method of controlling the presence of bacteria that belong to the group of enterobacteriaceae, for example, Salmonella and/or Escherichia species, in a monogastric animal, by feeding the monogastric animal with a feed material that comprises mycelium of Agaricus Blazei Murill (ABM mycelium), e.g., grown on a grain substrate.

### CROSS-REFERENCE TO RELATED APPLICATIONS

This application is a national phase entry under 35 U.S.C. § 371 of International Patent Application PCT/NL2017/050558, filed Aug. 25, 2017, designating the United States of America and published in English as International Patent Publication WO 2018/038614 A1 on Mar. 1, 2018, which claims the benefit under Article 8 of the Patent Cooperation Treaty to The Netherlands Patent Application Serial No. 2017374, filed Aug. 26, 2016.

### TECHNICAL FIELD

This disclosure pertains to a method of controlling the presence of bacteria that belong to the group of enterobacteriaceae in a monogastric animal, preferably pig and poultry, in particular, in a herd of pigs and a flock of birds.

### BACKGROUND

In order to keep monogastric animals, preferably pigs or poultry, healthy it is generally strived for to control the presence of bacteria in the pig or bird and a herd or flock to which this animal belongs. In particular, it is important to control the presence of bacteria that belong to the group of enterobacteriaceae since bacteria that belong to this group may not only be pathogenic to the pigs or birds themselves (infection thus reducing the herd's or flock's health status and hence its performance as measured, for example, in average daily weight gain, average weight at slaughter, age at slaughter weight etc.), but also pathogenic to consumers of the pig or poultry meat. Common methods to control the presence of the bacteria are to use antibiotics, and/or to vaccinate the pigs (for example, all pigs, or only the sows) in the herd or the birds in the flock. Another method used is containment (quarantine) of the pigs or poultry in combination with sterilizing their feed. This method, however, is not suitable for raising pigs or poultry for consumption purposes because of the high costs involved.

### BRIEF SUMMARY

Described is an alternative method of controlling the presence of bacteria that belong to the group of enterobacteriaceae in a monogastric animal, preferably pig or poultry, i.e., to reduce the amount of bacteria in the monogastric animal (preferably pig or poultry) and/or or to reduce one or more negative effects associated with the presence of the bacteria in the monogastric animal (preferably pig or poultry).

A method of controlling the presence of bacteria that belong to the group of enterobacteriaceae in a monogastric animal, preferably in pigs or poultry, has been devised, the method comprising feeding the monogastric animal, preferably pig or poultry, with a feed material that comprises mycelium of Agaricus Blazei Murill (ABM mycelium). Agaricus Blazei Murill is also called Agaricus Blazei Brasiliensis, Agaricus subrufescens, or Agaricus rufotegulis. At present, it is thought that Agaricus subrufescens is the correct name; however, in this application, the more common name Agaricus Blazei Murill will be used. Hereinbelow, the abbreviation ABM and the terms Agaricus Blazei Murill are used interchangeably.

Surprisingly, it was found that when feeding a monogastric animal, preferably a pig and/or poultry, with a feed material that comprises mycelium of ABM (which is the same as “ABM mycelium”), the presence of bacteria can be controlled effectively. In particular in pigs, it was found that significantly less bacteria are present in the pigs' feces, which inherently means that spread of the bacteria within the herd and/or flock is reduced. Besides, it was found that the general health status of the monogastric animal, preferably pigs and/or poultry, in the herd and/or flock could be improved, leading to a better performance of the herd/flock as a whole. The reason for the effective control of this particular group of closely related bacteria found in monogastric animals when feeding mycelium of ABM is not 100% clear. It has been described in the art, inter alia, in WO2013/171194, that the use of mycelium of ABM in the feed of laying hens improves egg laying, and possibly also egg shell quality and egg laying period. The use in monogastric animals, in particular, in pigs and/or in poultry, to control the presence of bacteria that belong to the enterobacteriaceae, however, is not described in the art.

The disclosed method also has its use in increasing average daily weight gain in a herd of pigs and/or flock of birds by feeding the pigs and/or poultry with a feed material that comprises mycelium of Agaricus Blazei Murill, as well as in a method to produce a pig feed premix and/or poultry feed premix (i.e., a nutrition incomplete feed material, to be mixed with other nutrients to provide for a more complete feed material), comprising mixing mycelium of Agaricus Blazei Murill with one or more additional feed components.

It is noted that the feed material comprising the ABM mycelium can be fed to a pig or birds, for example, by feeding the pig or birds with a nutrients composition without ABM mycelium and separately providing the ABM mycelium, for example, via the drinking water.

### Definitions

To control spreading of a bacterium within a herd of pigs and/or flock of birds means to take a measure that reduces the risk that the bacterial infection is transferred from a first pig or bird infected with this bacterium to another pig within the herd or another bird within the flock, for example, via feces or saliva of the first pig or chicken.

A pig is any animal belonging to the family of suidae.

A feed material is a composition comprising animal nutrients such as fats and/or proteins and/or carbohydrates that is or has been fed to an animal to provide in its metabolic requirements. Animal feed can be a nutritional complete feed (i.e., providing all required nutrients to support a normal metabolism of the animal), but it may also be a premix or other composition that contains only part of the required nutrients, to be mixed with other nutrients or fed separately from these other nutrients.

The total daily intake of feed is the complete mass of feed taken in per day, excluding drinking water.

### Embodiments

In a first embodiment of the disclosure, in which embodiment the pig is present in a herd of pigs, spreading of bacteria that belong to the group of enterobacteriaceae in the herd of pigs is controlled, by feeding the pigs with the feed material. It has been found that the spreading of the bacteria within a herd can be reduced since the use of the feed material according to the disclosure has a direct effect on shedding of the bacteria, and hence, inherently on the spreading of the bacteria within the herd. This is a very advantageous embodiment to actually control the presence of enterobacteriaceae in the herd of pigs.

In a further embodiment of the disclosure, in which embodiment the bird is present in a flock of birds, spreading of bacteria that belong to the group of enterobacteriaceae in the flock of birds is controlled, by feeding the birds with the feed material. It has been found that the spreading of the bacteria within a flock can be reduced since the use of the feed material according to the disclosure has a direct effect on shedding of the bacteria, and hence, inherently on the spreading of the bacteria within the flock. This is a very advantageous embodiment to actually control the presence of enterobacteriaceae in the flock of birds.

In another embodiment of the disclosure, in which embodiment the monogastric animal is present in a group of monogastric animals, spreading of bacteria that belong to the group of enterobacteriaceae in the group of monogastric animals is controlled, by feeding the monogastric animals with the feed material. It has been found that the spreading of the bacteria within a group can be reduced since the use of the feed material according to the disclosure has a direct effect on shedding of the bacteria, and hence, inherently on the spreading of the bacteria within the group. This is a very advantageous embodiment to actually control the presence of enterobacteriaceae in the group of monogastric animals.

Correspondingly, in a second embodiment of the disclosure, shedding of bacteria that belong to the group of enterobacteriaceae by the pig is reduced. In another embodiment, shedding of bacteria that belong to the group of enterobacteriaceae by the chicken is reduced. In a further embodiment, shedding of bacteria that belong to the group of enterobacteriaceae by the monogastric animal is reduced.

In another method according to the disclosure, the bacteria are chosen from the group consisting of Salmonella and Escherichia species. In particular, the bacteria are chose form the group that consist of Salmonella typhimurium, Salmonella enteritidis, Salmonella Heidelberg, Salmonella java and Escherichia coli. The current disclosure has been found particularly useful to control the presence of one or more of these pathogenic enterobacteriaceae within a pig.

In yet another embodiment, the ABM mycelium is fed at an amount of 0.01 to 10 kg per ton of total daily intake of feed by the (herd of) pig(s). In other words, the total amount of feed (excluding the drinking water) as is fed to the pigs comprise per 1000 kilograms, 0.01 to 10 kg of mycelium of ABM. This amount can be present in a nutritional complete feed as such, at a level of 0.01 to 10 kg per ton of that feed material, or may, for example, be present in a concentrated feed material (exceeding 10 kg/ton feed material) as long as the amount per total daily intake of feed is between 0.01 and 10 kg ABM mycelium per ton. In particular, the ABM mycelium is fed at an amount of 0.5 to 2 kg per ton of total daily intake of feed. These amounts appear to suffice for an effective use according to the current disclosure.

In a further embodiment, the ABM mycelium is fed at an amount of 0.01 to 10 kg per ton of total daily intake of feed by the (flock of) bird(s). In other words, the total amount of feed (excluding the drinking water) as is fed to the birds comprise per 1000 kilograms, 0.01 to 10 kg of mycelium of ABM. This amount can be present in a nutritional complete feed as such, at a level of 0.01 to 10 kg per ton of that feed material, or may, for example, be present in a concentrated feed material (exceeding 10 kg/ton feed material) as long as the amount per total daily intake of feed is between 0.01 and 10 kg ABM mycelium per ton. In particular, the ABM mycelium is fed at an amount of 0.5 to 2 kg per ton of total daily intake of feed. These amounts appear to suffice for an effective use according to the current disclosure.

In a further embodiment, the ABM mycelium is fed at an amount of 0.01 to 10 kg per ton of total daily intake of feed by the (group of) monogastric animal(s). In other words, the total amount of feed (excluding the drinking water) as is fed to the monogastric animals comprise per 1000 kilograms, 0.01 to 10 kg of mycelium of ABM. This amount can be present in a nutritional complete feed as such, at a level of 0.01 to 10 kg per ton of that feed material, or may, for example, be present in a concentrated feed material (exceeding 10 kg/ton feed material) as long as the amount per total daily intake of feed is between 0.01 and 10 kg ABM mycelium per ton. In particular, the ABM mycelium is fed at an amount of 0.5 to 2 kg per ton of total daily intake of feed. These amounts appear to suffice for an effective use according to the current disclosure.

In yet another embodiment, the ABM mycelium is grown on a grain substrate, in particular, a rye (Secale cereal) or millet (Panicum miliaceum) substrate. In a further embodiment, the grain substrate with the mycelium grown thereon is incorporated into the feed material. This appears to be a convenient method to provide the feed material. In particular, the ABM mycelium is grown on the grain substrate until the amount of mycelium is at least 10% (w/w) on dry weight of the mixture of grain and mycelium. Below this level, a relative high amount of the grain substrate needs to be mixed with other nutritional components in order to provide for an adequate economic effect. It is preferred that the ABM mycelium is grown on the grain substrate until the amount of mycelium is between 10 and 20% (w/w) on dry weight of the mixture of grain and mycelium.

In still another embodiment, the feed material additionally comprises one or more C₁-C₁₆ organic acids (which term also encompasses salts and esters of the acids, since both these forms are able to release the acid in the feed material), in particular, hydrocarbons with at least one carboxylic group. In the art it is known to use C₁-C₁₆ organic acids (or salts/esters thereof) as feed preservatives, i.e., to reduce microbial growth in the feed itself (during stocking of the feed). Little is known about the effect of these substances on the shedding of bacterial pathogens from an infected host, and thus on the spreading of these bacteria in an infected herd and/or flock. It now appears that these substances provide for an improved control of spreading bacteria that belong to the group of enterobacteriaceae. It was, inter alia, found that fatty acids, i.e., any acid comprising a hydrocarbon chain and at least one terminal carboxylic group, could be advantageously used in this embodiment. Typical acids are small chain C₁-C₇ acids such as formic acid, propionic acid, lactic acid, citric acid, fumaric acid, benzoic acid and sorbic acid, and C₇-C₁₆ medium chain acids such as caprylic acid, capric acid, lauric acid and palmitic acid. The acids can be applied alone, but it is also possible to apply mixtures incorporating various short chain and/or medium chain acids.

In a further embodiment, the one or more C₁-C₁₆ acids are present in an amount of 0.1 to 10 kg per ton of total daily intake of feed by the pig, in particular, in an amount of 0.5 to 6 kg per ton of total daily intake of feed by the pig.

In a further embodiment, the one or more C₁-C₁₆ acids are present in an amount of 0.1 to 10 kg per ton of total daily intake of feed by the chicken, in particular, in an amount of 0.5 to 6 kg per ton of total daily intake of feed by the bird.

In a further embodiment, the one or more C₁-C₁₆ acids are present in an amount of 0.1 to 10 kg per ton of total daily intake of feed by the monogastric animal, in particular, in an amount of 0.5 to 6 kg per ton of total daily intake of feed by the monogastric animal.

In another embodiment, the one or more acids are chosen from C₁-C₁₆ aliphatic acids.

### Examples

Example 1 describes an in vitro model study for assessing the effect of ABM mycelium on bacterial growth.

Example 2 describes an in vivo study for assessing the effect of ABM mycelium on bacterial shedding.

Example 3 describes further in vivo studies for assessing the effect of ABM mycelium on bacterial shedding.

Example 4 describes an in vivo study with broilers assessing the transmission of Salmonella.

### BRIEF DESCRIPTION OF THE DRAWINGS

FIG. 1 shows the effect of ABM mycelium on the shedding of Salmonella.

FIG. 2 shows the effect of ABM mycelium on diarrhea.

FIG. 3 shows the effect of ABM mycelium on the feed intake.

FIG. 4 shows the effect of ABM mycelium on the feed efficacy.

FIG. 5 shows the effect of ABM mycelium, combined with organic acids, on the shedding of Salmonella in a second in vivo study.

### DETAILED DESCRIPTION

### Example 1

Example 1 describes an in vitro model study for assessing the effect of ABM mycelium on bacterial adhesion. In this method the adhesion of Salmonella typhimurium to ABM mycelium is assessed.

Use was made of a 96-well plate on which the ABM mycelium was coated. For this, the ABM mycelium (in this and each case below a fermented rye product was actually used, in which product the amount of ABM mycelium was about 15% w/w) was suspended in PBS to a final concentration of 1% (w/v) and mixed thoroughly. Subsequently the suspension was centrifuged to remove insoluble material. Thereafter, the supernatant was used for coating the wells of the microtiter plate. For the adhesion assessment, a Salmonella typhimurium suspension was added to the microtiter plate. The plate was then incubated for 30 minutes and after this incubation step washed with PBS. Subsequently growth medium was added to the wells and the time to onset OD600 value was determined. The optical density (OD) measurement was used as a tool to compare numbers of adhered bacteria to the coated wells of the 96-well plate with different compounds. The initial cell density of adhered bacteria correlates with the time-dependent detection of the growth by optical density measurement. A shorter time to onset OD600 value represents more adhesion of bacteria to the substrate, and hence an expected higher decrease of in vivo growth.

The results for the test with Salmonella typhimurium showed that the average time to onset OD600 was 4.9 hours (±0.3 hour) as compared to the control (only PBS), which had an average time to onset OD600 of 7.3 hours (±0.1 hour). About twenty other compounds that were suspected of having a potential effect an adhesion (compounds not indicated in this example) showed an average time to onset OD600 generally between 5 and 8.5 hours.

In a second in vitro study, the test was repeated, and additionally the effect on Salmonella enteritidis and E. coli was measured. Also, the amount of ABM mycelium was used in the full amount (see above; denoted “100%”), half of this amount (“50%”) and a quarter of this amount (“25%”). The results are indicated here beneath in Table 1.

TABLE 1
Effect of ABM mycelium in various amounts on the
adhesion of various enterobacteriaceae, by measuring
the time to onset OD600 in hours.

| Compound | S. typhimurium | S. enteritidis | E. coli |
|---|---|---|---|
| Control | 7.0 | 6.3 | 7.1 |
| ABM 100% | 6.0 | 5.5 | 5.7 |
| ABM 50% | 5.7 | 5.5 | 5.9 |
| ABM 25% | 5.7 | 5.5 | 6.4 |

From the model studies, it appears that mycelium of ABM has a significant effect on the adhesion of various enterobacteriaceae. The effect appears to be independent of the type of bacterium despite the fact that, in particular, the Escherichia bacteria are of a completely different species than the Salmonella bacteria. The amount of ABM mycelium does not appear to be critical to obtain the adhesion effect as such.

### Example 2

Example 2 describes an in vivo study for assessing the effect of ABM mycelium on bacterial shedding. In this study it was assessed whether the effect on adhesion seen in vitro (see Example 1) corresponds to in vivo bacterial shedding, and thus inherently, to in vivo spreading of the bacterium in a herd of pigs. In particular, it was assessed whether by introducing ABM mycelium in the feed of the pigs, the shedding of viable bacteria could be reduced. As controls, a negative control using the regular feed was used, and as a positive control the same feed with added butyrate, a particular short chain fatty acid that is commercially used in poultry feed to reduce bacterial shedding. Apart from the feed received by the negative control animals, all feed was topped up with a regular C₁-C₁₆ organic acid blend containing a combination of formic and lactic acid at 4 liters per 100 kg to reduce microbial growth in the feed itself.

A total of 24 Topi*Hypor boar piglets were used. Only healthy male animals that did not receive antibiotics and that were negative for Salmonella (determined by qualitative examination of the feces) were included in the study. Animals were identified by uniquely numbered ear tags. Animals were divided over three treatment groups (8 animals per group) by weight and litter.

Piglets were individually housed (0.8×1.6 m) directly after weaning (24 days of age+/−3 days) in pens containing tenderfoot slatted floors. During the first 24 hours after weaning continuous light was provided, thereafter 16 hours light and 8 hours darkness. Piglets received feed and drinking water ad lib. The different treatments were administered in the feed during the total study period (from weaning until the end of the study) as indicated below in Table 2.

TABLE 2
Feed treatments

| Treatment | No. of animals | Additive | Inclusion level |
|---|---|---|---|
| Negative control | 8 | — | — |
| Butyrate (+ acid blend) | 8 | Butyrate | 6 kg/ton |
| ABM mycelium (+ acid blend) | 8 | ABM | 2 kg/ton |

After 10 days piglets were orally infected with Salmonella typhimurium (in BHI medium) given by a pre-inoculated feed matrix containing 1 ml 1*10⁹ cfu/ml. Oral infection was performed in this way during 7 consecutive days.

Fecal sampling was performed at day 1, 2, 3, 4, and 7 post Salmonella infection. Samples were stored at 4 degrees and analyzed the next day. Samples were diluted and homogenized in BPW containing novobiocin. Serial dilutions were made and plated onto selective chromogenic agar plates, and incubated o/n at 37° C. Typical Salmonella colonies were counted and the amount (cfu/gram) was calculated. Of each sample two presumptive Salmonella colonies were confirmed by qPCR for both Salmonella and Salmonella typhimurium. When no colonies were observed in the lowest dilution plates the samples were screened for Salmonella presence (qualitative) after pre-enrichment by the conventional MSRV/XLD method.

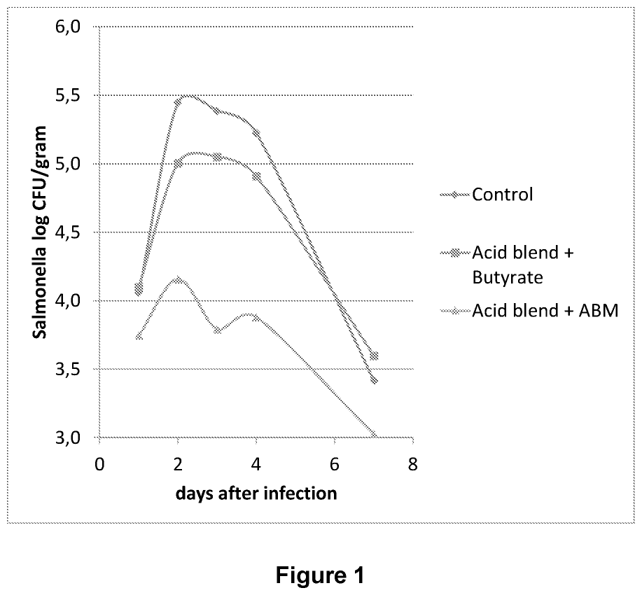

The results are indicated in FIG. 1, which shows the effect of ABM mycelium, in this case combined with organic acids, on the shedding of Salmonella. It appears that mycelium of ABM indeed has a significant effect on the shedding of viable salmonella bacteria. In particular, the effect is very large when compared to butyrate, a compound that is used in poultry for this purpose. It is thus also clear that the in vitro model (Example 1) is predictive for the in vivo reduction of bacterial shedding, and thus to the reduction of spreading of the bacterium throughout a herd of animals.

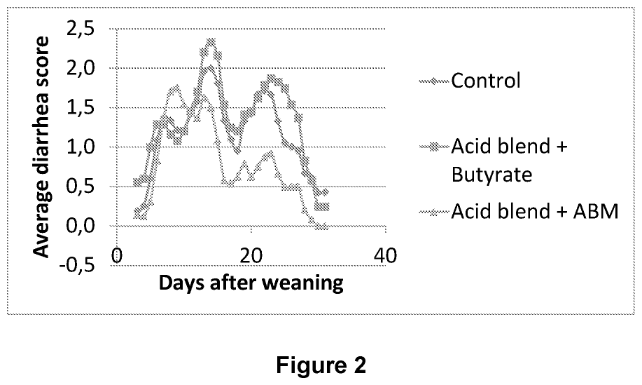

FIG. 2 shows the effect on diarrhea. A feces scoring was performed daily from day 3 after weaning until the end of the study. Diarrhea score was determined as: 0=normal feces; 1=flat feces; 2=wet feces; 3=watery feces. The results as depicted in FIG. 2 show a significant reduction of the ABM mycelium on diarrhea.

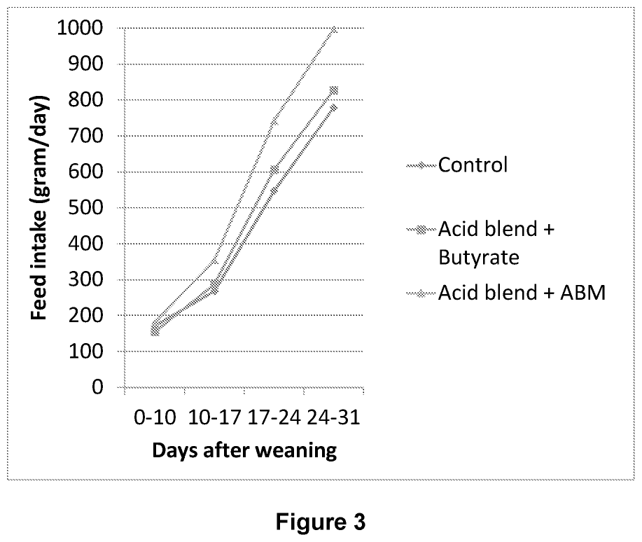

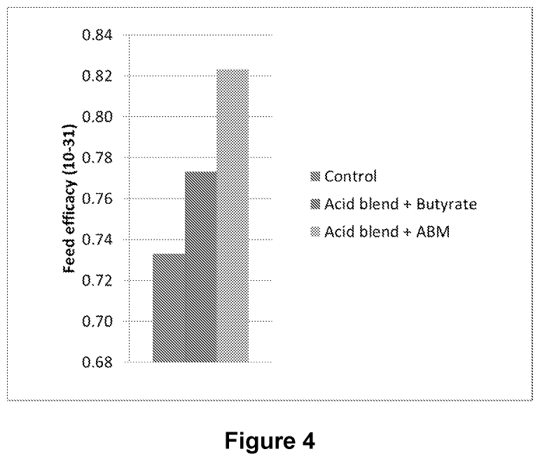

To assess performance, piglets were inspected daily. Body weight and feed intake were determined at weaning, before infection, and 7, 14, and 21 days after infection (day 0, 10, 17, 24, and 31). Feed efficacy was determined as gram growth/gram feed intake. FIG. 3 shows the effect of ABM mycelium on the feed intake. FIG. 4 shows the effect of ABM mycelium on the feed efficacy. The results show a significant positive impact on performance due to the presence of ABM mycelium in the feed.

### Example 3

Example 3 describes a second in vivo study for assessing the effect of ABM mycelium on bacterial shedding. In this study, as a positive control the acid blend was use, in order to assess the additional effect of ABM mycelium.

A total of 36 Topi*Hypor boar piglets were used. Only healthy male animals that did not receive antibiotics and that were negative for Salmonella (determined by qualitative examination of the feces) were included in the study. Animals were identified by uniquely numbered ear tags. Animals were divided over three groups (12 animals per group) by weight and litter.

Piglets were individually housed (0.8×0.8 m) directly after weaning (24 days of age+/−3 days) in pens containing tenderfoot slatted floors. The first 24 hours after weaning continuous light was provided, thereafter 16 hours light and 8 hours darkness. Piglets received feed and drinking water ad lib. The different treatments were administered in the feed during the total study period (from weaning until the end of the study) as indicated below in Table 3.

TABLE 3
Feed treatments

| Treatment | No. of animals | Acid blend | ABM |
|---|---|---|---|
| Negative control | 12 | None | — |
| Acid blend | 12 | 4 L/ton | — |
| Acid blend + ABM mycelium | 12 | 4 L/ton | 2 kg/ton |

After 8 days piglets were orally infected with Salmonella typhimurium (in BHI medium) given by a pre-inoculated feed matrix containing 1 ml 1*10⁹ cfu/ml. Oral infection was performed in this way during 7 consecutive days.

Fecal sampling was performed at day 1, 2, 3, 4, and 5 post Salmonella infection. Samples were stored at 4 degrees and analyzed the next day. Samples were diluted and homogenized in BPW containing novobiocin. Serial dilutions were made and plated onto selective chromogenic agar plates, and incubated o/n at 37° C. Typical Salmonella colonies were counted and the amount (cfu/gram) was calculated. Of each sample two presumptive Salmonella colonies were confirmed by qPCR for both Salmonella and Salmonella typhimurium. When no colonies were observed in the lowest dilution plates the samples were screened for Salmonella presence (qualitative) after pre-enrichment by the conventional MSRV/XLD method.

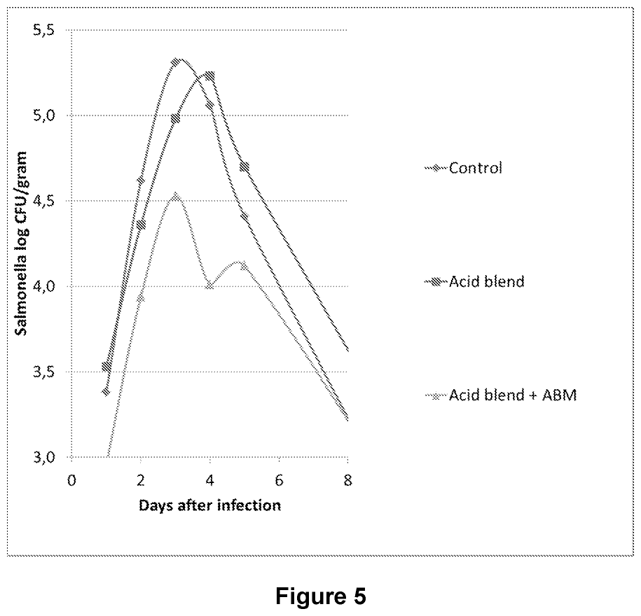

The results are indicated in FIG. 5. As the results show, the ABM mycelium has a significant effect on the bacterial shedding when compared to the use of the acid blend alone. This blend appears to have some effect on itself on the shedding but this effect is relatively small and not unambiguous towards reduction of shedding in this example.

The above in vivo experiment was repeated to assess the effect on Escherichia coli shedding by pigs. The experiment was run in correspondence with the salmonella experiment as described here above, with 10 animals being used per group. The results showed that on the day of artificial E. coli infection, none of the animals were positive in their feces for E. coli. At day 12, over 70% of the animals were positive in each group. Two days later, in the two control groups (negative control and acid blend group) the percentage of positive animals was 60%, whereas in the ABM group no shedders (0% of the animals tested positive for E. coli) were present at all.

### Example 4

An in vivo study was conducted using two groups, each group comprising 6 replicating pens with 30 birds. Three birds in each pen were infected with Salmonella enteritidis (seeder birds). The broilers were fed with a conventional broiler diet during 42 days. One group of broilers was treated with ABM mycelium on rye and an organic acid blend. The organic acid blend was a regular C₁-C₁₆ organic acid blend containing a combination of formic and lactic acid. The transmission of Salmonella to non-seeder birds was established by determining the number of infected or positive birds after 28 and 42 days.

After 28 days, the control (untreated) group consisted of 83% of infected birds, whereas the treated group contained 55% of infected birds. After 42 days, 60% of the birds were infected in the control group and 35% of positive birds in the treated group. This clearly demonstrates that the treatment aids in the containment of the Salmonella in the broilers.

1.-15. (canceled)

16. A method of controlling the presence of bacteria that belong to the group enterobacteriaceae in a monogastric animal, the method comprising:
feeding the monogastric animal a feed material comprising mycelium of Agaricus Blazei Murill (“ABM mycelium”).

17. The method according to claim 16, wherein the monogastric animal is present in a herd of monogastric animals, and spread of the bacteria in the group of monogastric animals is controlled by feeding the monogastric animals with the feed material.

18. The method according to claim 16, wherein shedding of the bacteria by the monogastric animal is reduced in comparison to a monogastric animal not fed the feed material.

19. The method according to claim 16, wherein the bacteria are selected from the group consisting of Salmonella and Escherichia species.

20. The method according to claim 19, wherein the bacteria are selected form the group consisting of Salmonella typhimurium, Salmonella enteritidis, Salmonella Heidelberg, Salmonella java, and Escherichia coli.

21. The method according to claim 16, wherein the ABM mycelium is fed in an amount of 0.01 to 10 kg per metric ton of total daily intake of feed by the monogastric animal.

22. The method according to claim 16, wherein the ABM mycelium is grown on a grain substrate.

23. The method according to claim 22, wherein the grain substrate with the ABM mycelium grown thereon is incorporated into the feed material.

24. The method according to claim 23, wherein the ABM mycelium is grown on the grain substrate until the amount of ABM mycelium is at least 10% (w/w) dry weight of the mixture of grain and mycelium.

25. The method according to claim 16, wherein the feed material further comprises:
at least one C₁-C₁₆ organic acid(s).

26. The method according to claim 25, wherein the at least one C₁-C₁₆ organic acid(s) is/are present in an amount of 0.1 to 10 kg per metric ton of total daily intake of feed by the monogastric animal.

27. The method according to claim 16, wherein the monogastric animal is a pig.

28. The method according to claim 16, wherein the monogastric animal is a chicken.

29. The method according to claim 22, wherein the grain substrate is a millet substrate.

30. The method according to claim 22, wherein the grain substrate is a rye substrate.

31. A method of increasing average daily weight gain in a group of monogastric animals, the method comprising:
feeding the group of monogastric animals a feed material comprising mycelium of Agaricus Blazei Murill.

32. A method of producing a monogastric animal feed premix, the method comprising:
mixing mycelium of Agaricus Blazei Murill with one or more additional feed components to produce the monogastric animal feed premix.
